(19) United States
(12) Patent Application Publication
(10) Pub. No.: US 2025/0284035 A1
(43) Pub. Date: Sep. 11, 2025

(54) Anti-Blue Light Lens Device and Preparation Method Thereof

(71) Applicants: Alis Tech Co., Ltd., Taoyuan City (TW); G2 New Visioncare International Inc., Belle Mead, NJ (US)

(72) Inventors: Ruei-Chuen Chung, Taoyuan City (TW); Chunxu Yang, Belle Mead, NJ (US); Ya-Wen Chung, Taoyuan City (TW)

(21) Appl. No.: 18/804,540

(22) Filed: Aug. 14, 2024

(30) Foreign Application Priority Data
Mar. 8, 2024 (TW) 113108615

(51) Int. Cl. G02B 1/115; G02C 7/10

(52) U.S. Cl. CPC G02B 1/115; G02C 7/104; G02C 7/108

(57) ABSTRACT

An anti-blue light lens device and preparation method thereof is disclosed. The lens device includes a lens base material, a plurality of anti-blue light layers, a plurality of hardened layers, a plurality of light reducing layers and a plurality of waterproof layers; wherein, the plurality of anti-blue light layers, the plurality of hardened layers, the plurality of light reducing layers and the plurality of waterproof layers are sequentially disposed on both sides of the lens base material. By impregnating the plurality of anti-blue light layers with a dyeing liquid of a specific color, the lens device with the anti-blue light is obtained.

### CROSS-REFERENCE TO RELATED APPLICATION

This application claims the benefit of Taiwan Patent Application No. 113108615, filed on Mar. 8, 2024, in the Taiwan Intellectual Property Office, the disclosure of which is incorporated herein in its entirety by reference.

### BACKGROUND OF THE INVENTION

### 1. Field of the Invention

The present invention relates to an anti-blue light lens device and preparation method thereof, more specifically to an anti-blue light lens device and preparation method thereof that can filter blue light of a specific wavelength and has high transmittance.

### 2. Description of the Related Art

With the advancement of science and technology, people's lives have become inseparable from mobile phones and computers. In the past, most knowledge acquisition and learning came from printed paper, but now people rely on image information transmitted by a mobile phone or computer screen produced with white LED backlight. However, the medical community points out that white LEDs emit a large amount of short-wave visible blue light centered near 450 nm, which can cause eye fatigue and increase the risk of macular degeneration.

For many children and teenagers who are in the stage of heavy learning, due to their lens being more transparent, they cannot effectively reduce the damage to the macular area caused by large amount of short-wave blue light. Even if they read and write with printed paper under the white LED desk lamp, they still cannot avoid the blue light damage from the white LED lights, not to mention that today's learning involves viewing mobile phone or computer screens in a close environment, which is even more worrying.

Moreover, when these children and teenagers are treated with medication to dilate their pupils due to myopia, although they can wear photochromic glasses in the sun during the day to improve photophobia discomfort, the photochromic glasses will fade to become transparent at night which cannot provide light-blocking protection, their dilated pupils bear more light damage than ordinary people at night. Therefore, how to protect human eyes from blue light damage that came from 3 C electronic products has become an urgent problem that needs to be solved.

The conventional technology uses a method of vacuum evaporation to reflect blue light, and provides quasi-transparent lenses that claim to achieve 40˜50% anti-blue light effect. Although the anti-blue light capabilities seems to be significant in numbers, it was actually referring to the sum of reflected blue light in the 380 nm˜500 nm wavelength range, but not to the actual wavelength of the blue light from LED backlight products which is highly concentrated between 440 nm˜460 nm, where the conventional anti-blue light transparent lenses may only filter less than 10% of the blue light concentrated in this wavelength range. As a result, although it is still possible to use these anti-blue light transparent lenses against sunlight, it is obviously insufficient when used against the concentrated blue light of white LED artificial light sources, instead only filters a very small amount of light emitted by white LEDs in the range of 380 nm˜440 nm.

In addition, the conventional dyeing technology is to mix premixed pigments into resin lenses and produce prescription lenses by infusion molding, which has the advantage of mass production, but will also cause inconsistent light filtering degrees between the middle and the periphery areas of the lens due to the difference in thickness between the areas of the prescription lens. On the other hand, conventional dyeing technology uses a pre-prepared dye of several pigments in a predetermined proportion, and during the dyeing process, due to different pigments in the dye heating and coloring the lens material at different speeds, or due to differences in the composition of the lens material batches resulting in spectral differences between pieces and causing chromatic aberration.

In view of the shortcomings of the above-mentioned conventional technology, it is necessary to develop an anti-blue light lens that can filter a large amount of short-wave visible blue light centered near 450 nm emitted by white LEDs and has high transmittance to avoid damage to human eyes caused by long-term or extensive viewing of computer or mobile phone screens.

### SUMMARY OF THE INVENTION

In view of the above-mentioned problems in the conventional art, the main objective of the present invention is to provide an anti-blue light lens device and preparation method thereof that can filter blue light of a specific wavelength and have high transmittance. Through special dyeing and light absorption technology, the anti-blue light lens device can completely block ultraviolet rays and further filter a large amount of short-wave visible blue light centered around 450 nm emitted by white LEDs, while having high light transmittance at the same time.

To achieve the foregoing objective, the first object of the present invention is to provide an anti-blue light lens device, in which the lens device comprises a lens base material, a plurality of anti-blue light layers, a plurality of hardened layers, a plurality of light reducing layers and a plurality of waterproof layers.

Wherein, the plurality of anti-blue light layers, the plurality of hardened layers, the plurality of light reducing layers and the plurality of waterproof layers are sequentially disposed on both sides of the lens base material to form a double-sided light filtering structure. In other words, the lens device uses the lens base material as the main body, and in the order of distancing from both sides of the lens base material, the anti-blue light layers, the hardened layers, the light reducing layers and the waterproof layers are sequentially stacked.

The lens base material is not particularly limited. Common resin lens materials can all be used as the lens base material, and the lens base material may be a base material for non-powered or powered refractive correction lens. Preferably, in order for the lens device to have an anti-ultraviolet function, the lens base material may be a lens base material with UV400 anti-ultraviolet function.

The hardened layer may protect the anti-blue light layer so the lens device may be more wear-resistant and scratch-resistant during future use, thereby extending its service life.

The light reducing layer can be used to reduce the reflection on the surface of the lens device and further improve the light transmission clarity of the lens device.

The waterproof layer can effectively increase the waterproof and anti-fouling performance of the lens device, thereby improving its overall appearance and quality.

On the other hand, the second object of the present invention is to provide a method for preparing an anti-blue light lens device, in which the preparation steps are as follows:
Step S1: forming an anti-blue light layer on a lens base material by sequentially immersing the lens base material in different dyeing liquids;
Step S2: forming a hardened layer on the anti-blue light layer by solidifying a hardener at high temperature after immersing the lens base material with the anti-blue light layer formed thereon in a hardener solution;
Step S3: forming a light reducing layer on the hardened layer by depositing a light reducing material using vacuum evaporation method on the lens base material with the hardened layer formed thereon;
Step S4: forming a waterproof layer on the light reducing layer by depositing a waterproof material using vacuum evaporation method on the lens base material with the light reducing layer formed thereon;
Step S5: obtaining the anti-blue light lens device.

In summary, the anti-blue light lens device of the present invention utilizes special dyeing and light absorption technology to process the dyeing liquid through heating, color matching, dyeing time control and other processing methods to form an anti-blue light layer after coloring the resin lens, therefore able to filter the large amount of short-wave visible blue light centered near 450 nm emitted from white LEDs, and thus solves the problem of conventional anti-blue light transparent lenses having poor blue light filtering in this wavelength range.

The technical features of the present invention will be described in detail below with specific embodiments and accompanying drawings, so that those with ordinary knowledge in the art can easily understand the purpose, features and advantages of the present invention.

### BRIEF DESCRIPTION OF THE DRAWINGS

Exemplary embodiments of the present invention will be more fully understood from the following detailed description and the accompanying drawings of various embodiments, which should not, however, be construed as limiting the present invention to the particular embodiments, but only for explanation and illustration purposes.

FIG. 1 is a schematic structural diagram of the anti-blue light lens device of the present invention;

FIG. 2 is a flow chart of the preparation steps of the anti-blue light lens device according to the present invention;

FIG. 3 is a schematic diagram of the spectrum of an LED lamp with a color temperature of 6000 before and after light filtering using the anti-blue light lens device of the present invention.

### DETAILED DESCRIPTION OF THE PREFERRED EMBODIMENTS

In order to clearly describe the features, content, advantages and effects of the present invention, the present invention is described in conjunction with the expression form of the accompanying drawings in detail. In addition, the drawings used in the disclosure are only for illustration and assist in understanding the description, and may not represent the actual proportions and precise configurations of the present invention in actual implementation. Therefore, the proportions and arrangement relationships of the attached drawings should not limit the scope of the present invention to practical implementation.

In order to have a more complete and clear disclosure of the technical content, the objective of the invention and the effects achieved by the present invention, reference will be made to the disclosed drawings and numerals for detailed description hereinafter.

All numbers in the present disclosure are understood to be modified by “about”. As used herein, the term “about” is meant to encompass a variation of ±10%.

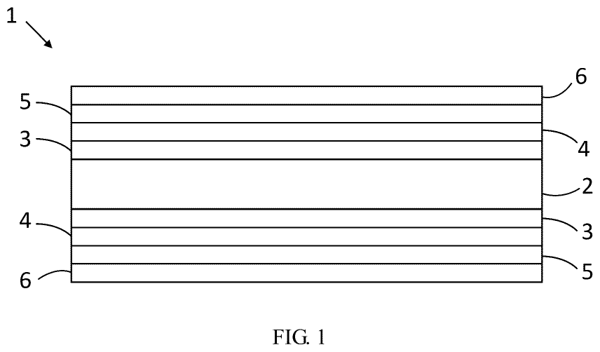

Referring to FIG. 1, which is a schematic structural diagram of the anti-blue light lens device of the present invention. The lens device 1 includes a lens base material 2, a plurality of anti-blue light layers 3, a plurality of hardened layers 4, a plurality of light reducing layers 5 and a plurality of waterproof layers 6.

Wherein, the plurality of anti-blue light layers 3, the plurality of hardened layers 4, the plurality of light reducing layers 5 and the plurality of waterproof layers 6 are sequentially disposed on both sides of the lens base material 2, thereby forming a double-sided light filtering structure. In other words, the lens device 1 uses the lens base material 2 as the main body, and in the order of distancing from both sides of the lens base material 2, the anti-blue light layers 3, the hardened layers 4, the light reducing layers 5, and the waterproof layers 6 are sequentially stacked.

The lens base material 2 is not particularly limited. Common resin lens materials can be used as the lens base material, and the lens base material 2 may be a base material for non-powered or powered refractive correction lens. For example, the lens base material 2 can be different resin lens materials produced by Shanghai Conant Optics Co., Ltd., such as resin lens materials with different refractive indexes such as CR39 UV++, 1.56 UV++, 1.60 Hi-Vex UV++ or 1.67 UV++, these resin lens materials have at least UV400 anti-ultraviolet function.

The anti-blue light layer 3 filters the large amount of short-wave visible blue light centered near 450 nm emitted from white LEDs; preferably, the anti-blue light layer 3 filters the short-wave visible blue light between 440 nm˜460 nm.

The hardened layer 4 may protect the anti-blue light layer 3 so the lens device 1 may be more wear-resistant and scratch-resistant during future use, thereby extending its service life.

The light reducing layer 5 can be used to reduce the reflection on the surface of the lens device 1 and further improve the light transmission clarity of the lens device 1.

The waterproof layer 6 can effectively increase the waterproof and anti-fouling performance of the lens device 1, thereby improving its overall appearance and quality.

Preferably, when the color concentration (dyeing degree) of the anti-blue light layer 3 is 15˜25% (that is, when the light transmittance is 75˜85%), the lens device 1 can filter more than 60% of the short-wavelength visible blue light between 440 nm˜460 nm, in this case, the anti-blue light layer 3 exhibits a yellow-green color; more preferably, the color concentration of the anti-blue light layer 3 is 20%, which can filter about 70% of the short-wavelength visible blue light between 440 nm˜460 nm.

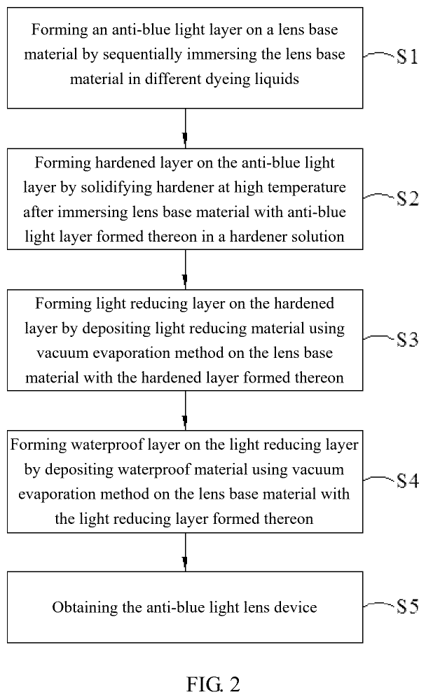

On the other hand, the second object of the present invention is to provide a method for preparing an anti-blue light lens device 1, in which the preparation steps are as follows (referring to FIG. 2):

Step S1: forming an anti-blue light layer 3 on a lens base material 2 by sequentially immersing the lens base material 2 in different dyeing liquids;

In step S1, the dyeing method is a thermal dyeing method which includes the following process: after the lens base material 2 is washed and cleaned, it is immersed in a container with a dyeing solution (purchased from Brain Power Inc. or CERIUM product group). The container automatically adjusts the temperature with a thermostat to maintain the dyeing solution at the required dyeing temperature to dye the lens base material 2 so that the anti-blue light layers 3 finally have a color concentration of 15˜25% on the lens base material 2; preferably, the dyeing temperature is 90˜97° C.; wherein different lens base materials have their own suitable dyeing temperatures, and the dyeing order and dyeing time of dyeing solutions of different colors are also different for different lens base materials. For example, when different resin lens materials produced by Shanghai Kangnet Optical Company are used as the lens base material 2, the corresponding dyeing sequence, dyeing time and dyeing temperature are as shown in Table 1 below:

TABLE 1

| | | Lens model | | | | | | | |
|---|---|---|---|---|---|---|---|---|---|
| | | | | | | 1.60 Hi-Vex | | | |
| | | CR39 UV++ | | 1.56 UV++ | | UV++ | | 1.67 UV++ | |
| Dyeing | | Temperature | | | | | | | |
| sequence | | 93~95° C. | | 90~93° C. | | 93~95° C. | | 96~97° C. | |
| 1 | Yellow dyeing liquid | 60~70 | sec | 50~60 | sec | 100~120 | sec | 150~180 | sec |
| 2 | Green dyeing liquid | 20~25 | sec | 15~20 | sec | 30~35 | sec | 50~60 | sec |
| 3 | Red dyeing liquid | 2~3 | sec | 3~5 | sec | 3~5 | sec | 8~10 | sec |
| 4 | Blue dyeing liquid | 2~3 | sec | 2~3 | sec | 3~5 | sec | 5~8 | sec |

Specifically, first the lens base material 2 is immersed in yellow dyeing liquid, dyed at the temperature and time showed in Table 1, taken out, washed in clean hot water to remove excess dyeing liquid, and then immersed in green dyeing liquid, dyed at the temperature and time showed in Table 1, taken out, and so on by analogy to dye the above four colors in sequence, and finally obtain the anti-blue light layer 3 having a color concentration of 15˜25% on the lens base material 2; preferably, the concentration of each dyeing liquid is about 6 to 10% (vol %).

Preferably, after the lens base material 2 is dyed in the above step S1, the formed anti-blue light layer 3 exhibits a color concentration (dyeing degree) of 15˜25%, that is, the light transmittance is 75˜85%; more preferably, the anti-blue light layer 3 exhibits a color concentration of 20%.
Step S2: forming a hardened layer 4 on the anti-blue light layer 3 by solidifying a hardener at high temperature after immersing the lens base material 2 with the anti-blue light layer 3 formed thereon in a hardener solution;
Step S3: forming a light reducing layer 5 on the hardened layer 4 by depositing a light reducing material using vacuum evaporation method on the lens base material 2 with the hardened layer 4 formed thereon;
Step S4: forming a waterproof layer 6 on the light reducing layer 5 by depositing a waterproof material using vacuum evaporation method on the lens base material 2 with the light reducing layer 5 formed thereon; and
Step S5: obtaining the anti-blue light lens device 1.

The lens device 1 obtained by the above preparation method exhibits a yellow-green color. The transmittance and short-wave blue light absorption of each wavelength were analyzed with a spectrum analyzer, and the results are shown in Table 2 and Table 3 below:

TABLE 2

| Wavelength | | |
|---|---|---|
| (full spectrum) | Transmission | target value |
| 380 nm~780 nm | 80% | ≥80% |

TABLE 3

| Wavelength | Transmission | Absorption | Target value | Remark |
|---|---|---|---|---|
| 400 nm | 0% | 100% | 100% | Base material |
| | | | | absorption |
| 440 nm | 18.58% | 81.42% | >80% | Dye absorption |
| 450 nm | 26.48% | 73.52% | >65% | Dye absorption |
| 460 nm | 37.14% | 62.86% | >60% | Dye absorption |

It can be seen from the experimental results in Table 2 and Table 3 that the lens device 1 can indeed filter more than 60% of the short-wavelength visible blue light between 440 nm and 460 nm, and has a transmittance of about 80%.

Next, the lens device 1 was further used to conduct the following retinal cell survival rate experiments and retinitis and melatonin suppression alleviation effect detection experiments to confirm the anti-blue light efficacy of the lens device 1.

### Experimental Example 1: Retinal Cell Survival Rate Experiment

The lens device 1 was sent to the Retina Cell Laboratory of National Taiwan University Hospital to conduct a 24-hour retinal cell survival rate experiment using 661W mouse retinal photoreceptor cell line; the 661W mouse retinal photoreceptor cells were derived from mouse retinal tumors and contain pigment proteins unique to cone cells such as transducin and arrestin, and are the most commonly used cells that are light-sensitive and easy to culture. At the same time, using such cells for pioneering experiments can greatly reduce the number of animals used in future animal experiments.

The experimental steps for retinal cell survival rate are as follows:
1. Cell culture: Seed 661W cells in a sterile cell culture dish with a diameter of 10 cm, and cultured in a cell culture incubator at 37° C. with a humidified atmosphere containing 5% CO2; the cell culture medium contains 10% FBS, 100 U/mL penicillin, 100 mg/mL streptomycin in DMEM. Every two or three days, the cells were excised with trypsin and subcultured.
2. Pre-irradiation treatment: After detaching the attached cells with trypsin, the cells were first stained with trypan blue and then counted; then, according to the calculation results, diluted to a cell solution containing 3×10³ cells per 1000 μL. Then, in a 96-well sterile cell culture plate, 100 μL of cell solution was planted in each well, and incubated in a cell culture incubator containing 5% CO2 at 37° C. for 24 hours. After 24 hours of cell adhering, the culture solution was changed to DMEM containing 1% FBS and conduct lighting experiments under different conditions.
3. Irradiation: Move the 96-well sterile cell culture plate into a cell culture incubator for culture, and divide the cells into a control group and an experimental group; wherein, the control group is a non-illumination group, and its cells do not receive illumination, while the cells in the illumination group are exposed to white light LED (illumination of 800 lux) and color temperature of 5600K for 24 hours. In order for the cells to receive the same light energy, a layer of light-homogenizing film is added to the white LED light source, which can effectively convert the point or linear light source into a soft, uniform surface light source which is evenly diffused. The experimental group placed the lens device 1 on the light-homogenizing film under the petri dish, and each experiment was repeated three times to reduce experimental errors.
4. CCK-8 (Cell Counting kit-8) assay to detect cell survival rate: Seed 3×10³ 661W cells in a 96-microwell plate. After 24 hours of cells adhering, replace the culture medium to DMEM with 1% FBS then subjected to illumination experiments under different conditions; then, after 24 hours of illumination, 10 μL of CCK-8 was added to each microwell and reacted at 37° C. for 2 hours, and finally the absorbance value of the solution at 450 nm was detected with a microplate analyzer (Microplate reader). The cell survival rate is calculated by using the absorbance value of the non-illuminated group as the control absorbance value. Divide the absorbance value of the experimental group by the control absorbance value and then multiply by 100% to obtain the cell survival rate.
5. Statistical analysis: A two-way analysis of variance (ANOVA) was performed to determine whether the lens device 1 can significantly protect retinal photoreceptor cells, wherein a P value<0.05 was considered to have a significant difference. The results are shown as follows in Table 4.

TABLE 4

| | | Cell | | |
|---|---|---|---|---|
| | | survival | Experimental | |
| | Sample | rate | conditions | Remarks |
| Experimental | Anti-blue light lens | 75.70% | 800 lux white light | P < 0.05 |
| group | | | LED, color temperature | |
| Control | W/O Anti-blue light | 56.47% | 5600K | |
| group | lens | | | |

It can be seen from Table 4 that when the lens device 1 is placed, the cell survival rate is significantly improved, which means that the lens device 1 can indeed improve the survival rate of retinal photoreceptor cells.

### Experimental Example 2: Detection of Photoretinitis Alleviation Effect and Melatonin Suppression/Alleviation Effect

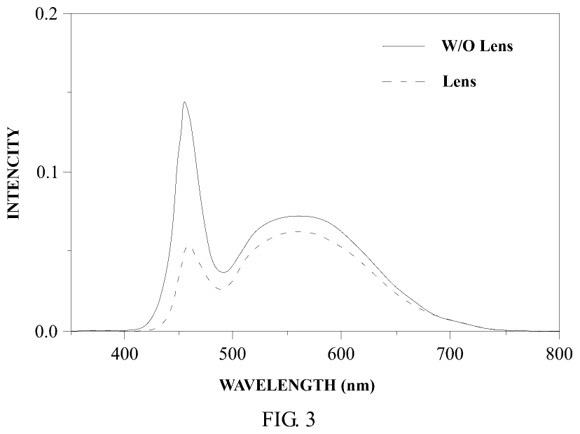

The lens device 1 was sent to the Nano-Organic Optoelectronics Laboratory of Tsinghua University, and an LED lamp with a color temperature of 6000K was used to conduct the photoretinitis alleviation experiment and the melatonin suppression/alleviation experiment. This experiment was performed by placing the lens device 1 at a distance of 18 centimeters from a light source, and the filtered spectrum was measured with a spectrometer (model PR-655) at a distance of 8 centimeters from the other side of the lens device 1 (i.e., the side opposite to the light source), and then conduct illumination measurement by an illuminance meter (model LX-101), and finally obtain the spectrum of the LED lamp before and after light filtering (also referring to FIG. 3). The results are shown in Table 5 below.

TABLE 5

| | Control group | Experimental |
|---|---|---|
| Item | (no lens) | group |
| Illumination (lux) | 1704 | 1112 |
| Illumination difference (%) | −35 | |
| Melatonin suppression sensitivity MSS@460 nm (%) | 5.2 | 25 |
| Melatonin suppression and alleviation effect (%) | +52 | |
| Maximum allowable exposure limit MPE@100 lux (sec) | 313 | 671 |
| Photoretinitis alleviation effect @ 100 lux (sec) | +114 | |
| Maximum allowable exposure limit MPE@10 lux (sec) | 3132 | 6713 |

| | |
|---|---|
| Photoretinitis alleviation effect @10 lux (sec) | +114 |

| | Control group | Experimental |
|---|---|---|
| Spectral influence detection | (no lens) | group |
| Natural spectral similarity index SRI (%) | 93 | 92 |

| | |
|---|---|
| SRI difference (%) | −1 |

SRI: surface regularity index, a parameter used to reflect the regularity of the corneal surface within 4.5 mm of the corneal pupil area.

As can be seen from FIG. 3, after being filtered by the lens device 1, the light intensity of each waveband decreases significantly, and it can also be seen from Table 5 above that the photoretinitis alleviation effect and melatonin suppression/alleviation effect is also significantly improved; therefore, these results can further confirm that the lens device 1 has a protective effect on the retina of the eye and the body.

In summary, the anti-blue light lens device of the present invention utilizes special dyeing and light absorption technology to process the dyeing liquid through heating, color matching, dyeing time control and other processing methods to form an anti-blue light layer after coloring the resin lens, therefore able to filter the large amount of short-wave visible blue light centered near 450 nm emitted from white LEDs, and thus solves the problem of conventional anti-blue light transparent lenses having poor blue light filtering in this wavelength range.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An anti-blue light lens device, comprising:
a lens base material;
a plurality of anti-blue light layers, respectively disposed on both sides of the lens base material;
a plurality of hardened layers, respectively disposed on one side of the plurality of anti-blue light layers facing away from the lens base material;
a plurality of light reducing layers, respectively disposed on one side of the plurality of hardened layers facing away from the lens base material; and
a plurality of waterproof layer, respectively disposed on one side of the plurality of light reducing layer facing away from the lens base material, wherein
the plurality of anti-blue light layers exhibit a yellow-green color.

2. The lens device of claim 1, wherein the lens base material is made of a resin material, and the lens base material is a base material for non-powered or powered refractive correction lens.

3. The lens device of claim 1, wherein the plurality of anti-blue light layers exhibit a yellow-green color with color concentration of 15˜25%.

4. The lens device of claim 1, wherein the lens device is able to filter about 60% or more of short-wave visible blue light between 440 nm˜460 nm.

5. The lens device of claim 1, wherein the plurality of anti-blue light layers are made by dyeing the lens base material using a thermal dyeing method, in which the dyeing temperature is 90˜97° C.

6. The lens device of claim 5, wherein the thermal dyeing method is to sequentially dye the lens base material with a yellow dyeing liquid, a green dyeing liquid, a red dyeing liquid and a blue dyeing liquid; and the lens base material is washed in clean hot water before dyeing in different dyeing liquids.

7. A method for preparing an anti-blue light lens device, comprising the following steps:
step S1: forming an anti-blue light layer on a lens base material by sequentially immersing the lens base material in different dyeing liquids;
step S2: forming a hardened layer on the anti-blue light layer by solidifying a hardener at high temperature after immersing the lens base material with the anti-blue light layer formed thereon in a hardener solution;
step S3: forming a light reducing layer on the hardened layer by depositing a light reducing material using vacuum evaporation method on the lens base material with the hardened layer formed thereon;
step S4: forming a waterproof layer on the light reducing layer by depositing a waterproof material using vacuum evaporation method on the lens base material with the light reducing layer formed thereon; and
step S5: obtaining the anti-blue light lens device, wherein
the anti-blue light layer exhibits a yellow-green color.

8. The method of claim 7, wherein the lens device is able to filter about 60% or more of short-wave visible blue light between 440 nm˜460 nm.

9. The method of claim 7, wherein in step S1, the anti-blue light layer is made by dyeing the lens base material using a thermal dyeing method, in which the dyeing temperature is 90˜97° C.

10. The method of claim 9, wherein the thermal dyeing method is to sequentially dye the lens base material with a yellow dyeing liquid, a green dyeing liquid, a red dyeing liquid and a blue dyeing liquid; and the lens base material is washed in clean hot water before dyeing in different dyeing liquids.
